(19) United States
(12) Patent Application Publication
(10) Pub. No.: US 2004/0169709 A1
(43) Pub. Date: Sep. 2, 2004

(54) Printing device and method

(76) Inventors: Geoff Wotton, Battle Ground, WA (US); Carl R. Reid, Camas, WA (US); Ernesto Garay, Gresham, OR (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/377,386

(22) Filed: Feb. 28, 2003

(51) Int. Cl. B41J 2/01

(52) U.S. Cl. 347/101

(57) ABSTRACT

In accordance with one embodiment, a printing device includes a sub-assembly for positioning ink on a print media. The printing device also includes a conditioning sub-assembly having a plurality of components, wherein the plurality of components has a first configuration to transfer conditioning material to the print media as the print media is fed through the printing device and a second configuration that does not transfer conditioning material to the print media as the print media is fed through the printing device.

### BACKGROUND

Ink jet printing systems typically operate by ejecting ink from one or more print cartridges onto a print media, such as paper, to form a print image. The quality of the print image can be affected by, among other factors, the characteristics of the print media. In some instances, print image quality can be improved by conditioning the print media, while in other instances, such conditioning may not be desired. Therefore, a need exists to selectively apply a conditioning material to print media utilized in various printing systems.

### BRIEF DESCRIPTION OF THE DRAWINGS

FIG. 1 shows a block diagram that illustrates various components of an exemplary printing device in accordance with one embodiment.

FIGS. 2-3 show a side view of a portion of an exemplary printing device in accordance with one embodiment.

FIG. 4 shows a perspective view of a portion of an exemplary printing device in accordance with one embodiment.

FIG. 5 shows a side view of a portion of an exemplary printing device in accordance with one embodiment.

FIG. 6 shows a flow diagram comprising acts in accordance with one exemplary method in accordance with one embodiment.

### DETAILED DESCRIPTION OF THE PREFERRED EMBODIMENTS OVERVIEW

In accordance with various embodiments, methods and systems are described to allow a conditioning material to be selectively applied to a print media in a printing device. A conditioning material can, in some embodiments, increase the print image quality on a given print media. The conditioning material can contribute to print image quality, through one or more of several mechanisms. For example, in some embodiments, the conditioning material decreases bleeding of the ink used to form the print image that can otherwise blur the print image.

### EXEMPLARY PRINTING DEVICE

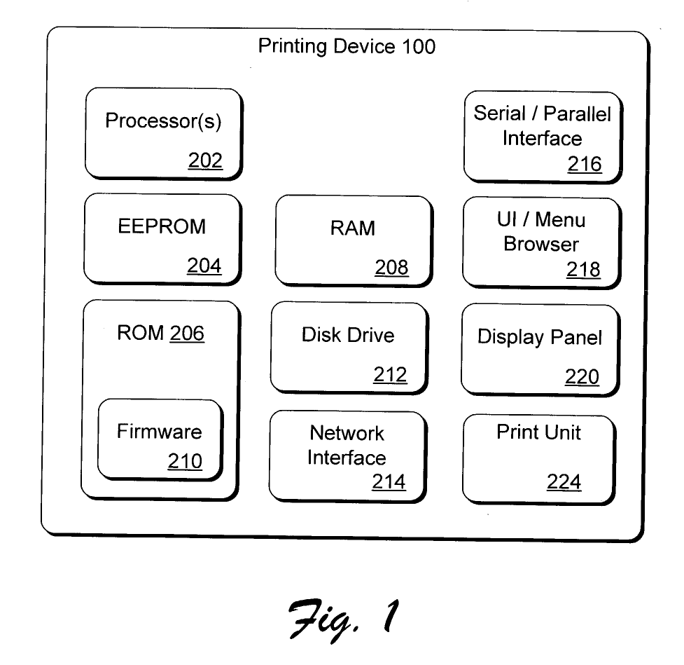

FIG. 1 illustrates various components of an exemplary printing device 100. In this embodiment, printing device 100 comprises an ink jet printer, but the described embodiments are equally applicable to other types of printing devices such as laser printers, among others.

Printing device 100 may include one or more controllers that are embodied as one or more processors 202 to control various printing operations, such as media handling and ink ejection.

Printing device 100 may have an electrically erasable programmable read-only memory (EEPROM) 204, ROM 206 (non-erasable), and a random access memory (RAM) 208. Although printing device 100 is illustrated having an EEPROM 204 and ROM 206, a particular printing device may only include one of the memory components. Additionally, although not shown, a system bus (not shown) may connect the various components within the printing device 100.

The printing device 100 may also have a firmware component 210 that is implemented as a permanent memory module stored on ROM 206. The firmware 210 is programmed and tested like software, and is distributed with the printing device 100. The firmware 210 may be implemented to coordinate operations of the hardware within printing device 100 and contains programming constructs used to implement such operations.

Processor(s) 202 process various instructions to control the operation of the printing device 100 and to communicate with other electronic and computing devices. The memory components, EEPROM 204, ROM 206, and RAM 208, store various information and/or data such as configuration information, fonts, templates, data being printed, and menu structure information. Although not shown, a particular printing device may also include a flash memory device in place of or in addition to EEPROM 204 and ROM 206.

Printing device 100 may also include a disk drive 212, a network interface 214, and a serial/parallel interface 216. Disk drive 212 provides additional storage for data being printed or other information maintained by the printing device 100. Although printing device 100 is illustrated having both RAM 208 and a disk drive 212, a particular printing device may include either RAM 208 or disk drive 212, depending on the storage needs of the printer. For example, some printing devices may include a small amount of RAM 208 and no disk drive 212, thereby reducing the manufacturing cost of the printing device.

Network interface 214 provides a connection between printing device 100 and a data communication network. The network interface 214 allows devices coupled to a common data communication network to send print jobs, menu data, and other information to printing device 100 via the network. Similarly, serial/parallel interface 216 provides a data communication path directly between printing device 100 and another electronic or computing device. Although printing device 100 is illustrated as having a network interface 214 and serial/parallel interface 216, a particular printing device may only include one such interface component.

Printing device 100 may also include a user interface and menu browser 218, and a display panel 220. The user interface and menu browser 218 allow a user of the printing device 100 to navigate the printing device's menu structure. User interface 218 may be implemented as indicators or a series of buttons, switches, or other selectable controls that are manipulated by a user of the printing device. Display panel 220 is a graphical display that provides information regarding the status of the printing device 100 and the current options available to a user through the menu structure.

Printing device 100 also includes a print unit 224 which includes mechanisms arranged to selectively apply ink to a print media such as paper, plastic, fabric, among other suitable materials, to form a print image in accordance with print data corresponding to a print job. “Ink” as used herein includes both liquid inks such as those used in ink jet printers, and other forms such as toner particles used in laser printers.

The quality of the print image created by a given printing device can be affected by among other factors, the type and quality of print media upon which the image is formed. For example, photo-grade paper often produces a higher quality image than “standard” printer paper. A photo-grade paper can have a more uniform surface, and is treated with a type of conditioning material that can reduce the tendency of the ink droplets to diffuse or bleed on the print media thus blurring the image. While photo-grade paper can allow a given printing device to produce higher quality images, it may not be needed for many print jobs and its cost can be prohibitive to many users.

### EXEMPLARY EMBODIMENTS AND METHODS

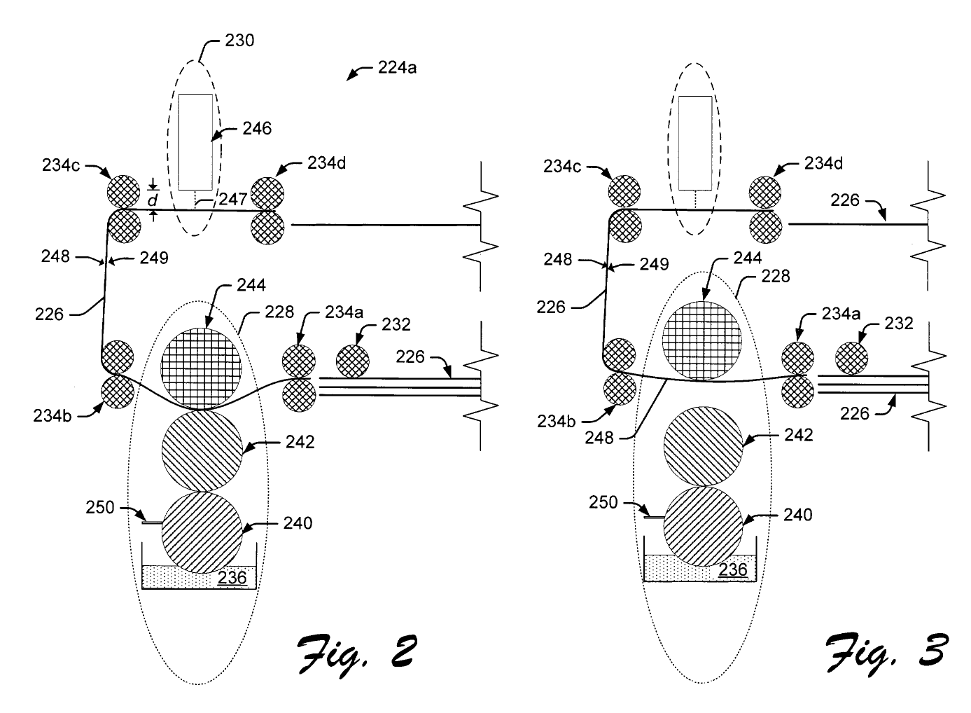

FIGS. 2 and 3 show cross-sectional views of portions of one exemplary print unit 224a capable of forming a print image on print media 226. The print unit 224a can comprise functional sub-units, such as conditioning sub-assembly 228 and ink ejecting sub-assembly 230 which will be discussed in more detail below.

In some embodiments, individual components of the print unit 224a comprise pick roller 232, one or more sets of feed rollers 234a-d, a source of conditioning material 236, pick-up roller 240, transfer roller 242, pinch roller 244, and a print cartridge 246.

In some embodiments, print media 226, such as paper, can be picked from a stack by pick roller 232 and moved through the print unit 224a by sets of feed rollers, such as 234a-d. The feed rollers can move the print media through and/or past conditioning sub-assembly 228 and through and/or past ink ejecting sub-assembly 230 which can comprise print cartridge 246 in some embodiments.

The print cartridge 246 ejects an ink droplet 247 across a distance d onto a target location on print media's first surface 248. This process is repeated multiple times to form a print image on the print media 226. Though not shown in the illustrated embodiments, some exemplary printing devices are configured to also print on the print media's second surface 249.

The components of the conditioning sub-assembly 228 can be arranged in a first configuration that transfers conditioning material 236 to the print media 226 as it is fed through the printing device. For example, FIG. 2 shows one such first configuration.

FIG. 2 shows conditioning sub-assembly 228 having a plurality of components including pick-up roller 240, transfer roller 242, and pinch roller 244. In this embodiment, pick-up roller 240 can move in a clockwise direction and a portion of the pick-up roller contacts conditioning material 236, some of which is transferred to the pick-up roller as it turns. In some embodiments, doctor blade 250, can be utilized to remove excess conditioning material from the pick-up roller.

The amount of conditioning material on the pick-up roller 240 can also be controlled in some embodiments, by the surface characteristics of the pick-up roller. For example, in some embodiments, imperfections or texture of varying dimensions can be incorporated on the surface of the pick-up roller to control the amount of conditioning material which adheres thereto. Alternatively or additionally, the amount of conditioning material on the pick-up roller can, in some embodiments, be controlled by, among others, the type of doctor blade 250 selected, the pressure exerted by the doctor blade on the pick-up roller and the surface characteristics of the pick-up roller.

In the described embodiment, as the pick-up roller 240 continues to turn clockwise, the surface of the pick-up roller and the associated conditioning material contact transfer roller 242 and some conditioning material is transferred to the transfer roller which turns counterclockwise.

Pinch roller 244 can cause the print media's first surface 248 to contact transfer roller 242. For example, in some embodiments, pinch roller 244 can apply a downward pressure to the print media 226 squeezing it between the pinch roller and the transfer roller. This configuration can transfer conditioning material to the print media's first surface 248.

A conditioning material can be any material that can increase print image quality in at least some circumstances. For example, in some embodiments, a conditioning material can comprise a material that reduces ink bleed from a target location on the print media. In some of these examples, the conditioning material can comprise a hydrophobic material that helps to reduce bleeding of liquid ink away from the target location. Examples of such hydrophobic conditioning materials include latex, such as Elmer's Glue®.

In still another example, the conditioning material can comprise a fixer that reacts with the ink or otherwise causes the ink to become generally non-flowing. Examples of suitable fixers include, but are not limited to, acrylic polymers.

Some of the conditioning materials aid in improving print image quality in other ways. For example, in some embodiments, conditioning material can comprise a hydrophilic material, such as water, which is applied to substantially the entire surface of an individual page of print media, such as standard printer paper, prior to a print image being formed on the paper.

The application of water can uniformly pre-expand the page. Without such pretreatment, a portion of the page that receives ink during image formation can expand relative to a non ink-covered portion. This uneven expansion can cause waviness on the paper.

The waviness can detract from the quality of the finished page. Further, the waviness can cause the distance d as described above in relation to FIG. 2 to vary over the area of the page. This can degrade image quality since a given printing device and associated print cartridge is often designed to function at an essentially constant value of d (shown FIG. 2). The variation can, among other factors, affect trajectory compensation parameters established for the printing device and contained in software/firmware therein which controls the ejection of ink from the print cartridge.

In some embodiments, the components of the conditioning sub-assembly 228 can be arranged in a second configuration which does not transfer conditioning material to the print media as it is fed through the printing device. For example, FIG. 3 shows one such second configuration.

As shown in FIG. 3, print media 226 is fed by sets of print rollers 234a-d through conditioning assembly 228. Print media contacts pinch roller 244, but not transfer roller 242 and the conditioning material 236 positioned, thereon. In this embodiment, pinch roller 244 is more distant from the transfer roller than in the embodiment shown in FIG. 2. In this embodiment, the second configuration is achieved by moving pinch roller 244 relative to transfer roller 242, but this is just one suitable configuration. For example, in other embodiments, alternatively or additionally to moving pinch roller 244, transfer roller 242 and pick-up roller 240 can be moved to achieve the second configuration.

Conditioning sub-assemblies, having such first and second configurations, can further be utilized to separate pinch roller 244 from transfer roller 242 when no print media is positioned between them. This can reduce conditioning material from inadvertently being transferred from transfer roller 242 to pinch roller 244 and subsequently to the print media's second side 249.

Further still, this configuration can allow print media to pass through the printing device without receiving conditioning material if so desired. For example, if transparencies are utilized as the print media for a given print job, the conditioning sub-assembly can be maintained in the second configuration so that conditioning material is not applied to them.

In another example, the ability to select between first and second configurations can allow conditioning material to be transferred to a portion of an individual print media sheet, as desired. For example, in some embodiments, conditioning material may be applied to a portion of a page or sheet where a graphic image is formed while other portions of the page, such as those receiving text, do not have conditioning material applied to them. Such a configuration may reduce the amount of conditioning material usage while allowing the printing device to form a higher quality print image on a given print media than could otherwise be obtained. Various suitable printing devices can possess some or all of these functionalities.

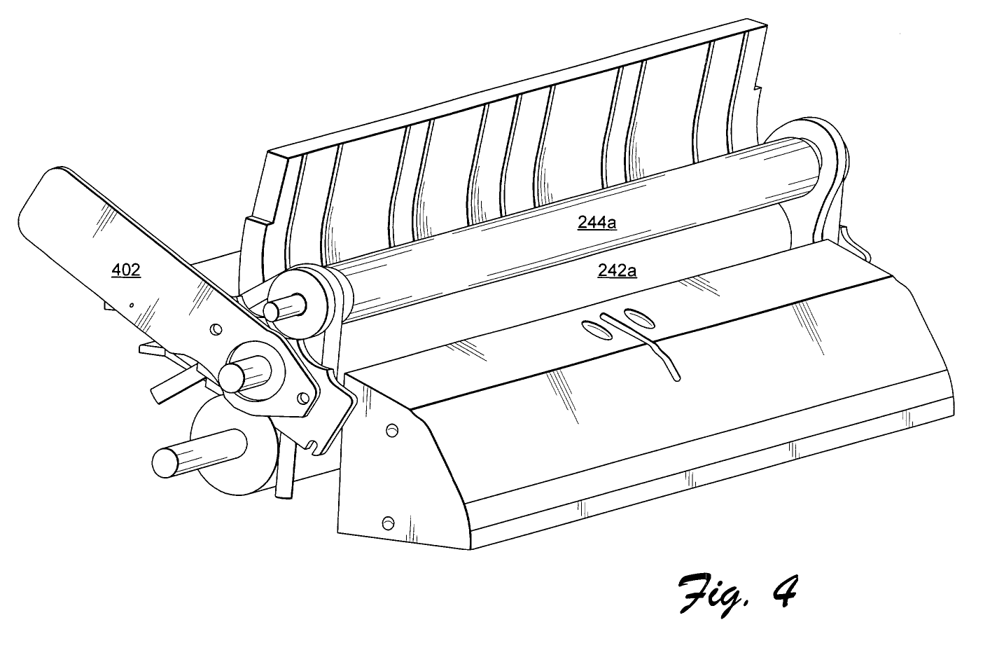

FIG. 4 shows an example of how conditioning sub-assembly 228 (Not shown in FIG. 4) can be moved from a first position to a second position. In this example, a cam lever 402 can move pinch roller 244a between a position which contacts transfer roller 242a to a second non-contacting position. The cam lever 402 can be controlled manually by a user or can be controlled by a controller such as processor 202. The controller can move the cam lever with a solenoid or stepper motor among other means. Other suitable movement means will be recognized by the skilled artisan.

Alternatively or additionally to the cam lever, other embodiments can use other suitable means for moving a conditioning sub-assembly between first and second configurations. For example, in some embodiments, a solenoid and a biasing means, such as a spring, can be utilized in cooperation, so that the biasing means positions a conditioning sub-assembly in one configuration until the solenoid is activated to move one or more of the sub-assembly's component to achieve a second configuration of the conditioning sub-assembly. When the solenoid is deactivated, the sub-assembly can return to the first configuration. Such a system can be controlled by processor 202.

In some embodiments, a mechanism or mechanisms may be included to reduce inadvertent contact between conditioning material from the conditioning sub-assembly and ink from the ink ejecting sub-assembly. Some of the conditioning materials, such as fixers, are inherently designed to react with and/or otherwise solidify ink. Various forms of ‘off-target ink’ such as aerosol droplets, can exist within a printing device especially proximate to the ink-ejecting sub-unit. If this off-target ink contacts conditioning material, undesired ink may appear on the print media. Similarly, if conditioning material unintentionally contacts the ink-ejecting sub-unit's print cartridge the performance of the print cartridge may be impaired.

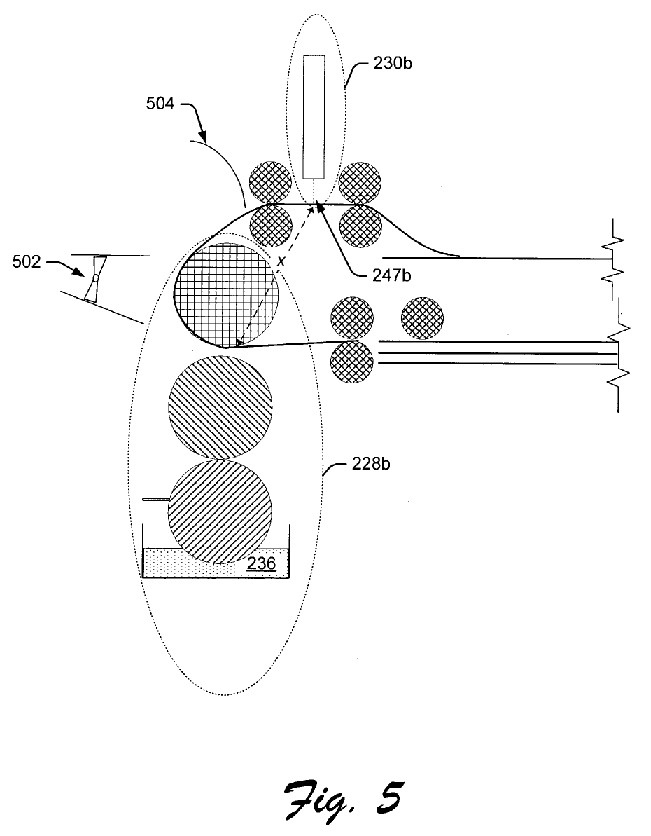

FIG. 5 shows three examples of suitable mechanisms for reducing unintended contact of conditioning material 236 of conditioning sub-unit 228b from contacting ink 247b from ink-ejecting sub-unit 230b. The examples comprise an evacuation system comprising fan 502, a physical barrier 504 and physical separation, indicated here as distance x between the two sub-units. Other embodiments may use some or all of these mechanisms, as well as other suitable mechanisms, as will be recognized by the skilled artisan.

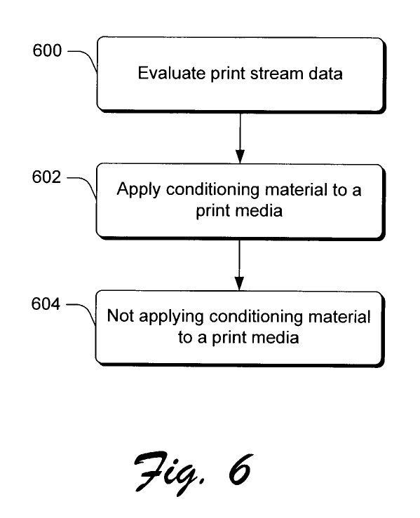

FIG. 6 shows a flow diagram that describes a method in accordance with one embodiment. The exemplary method evaluates print stream data at 600 to determine whether a conditioning material should be applied to print media upon which an image representing the print stream data is to be formed.

In some embodiments, such evaluation can be conducted for the print job as a whole. Other embodiments can evaluate on a page-by-page basis. Still other embodiments can conduct separate evaluations for subsets of an individual page comprising a print job. For example, an evaluation may be conducted for those areas that represent graphic images on a page and a separate evaluation conducted for those areas receiving text. In some of these embodiments, the evaluation can be based, at least in part, on user input regarding print quality preferences. For example, in some embodiments, a user may elect to apply conditioning material only to graphic image portions of a print job.

This exemplary method applies conditioning material to a print media at 602 if the evaluation indicates that print quality can be improved with application of the conditioning material. In some embodiments, such applications can cover substantially whole pages, while other application can cover individual portions of a given page.

Some embodiments apply conditioning material by positioning a first roller a first distance from a second roller when a print media is positioned between the first roller and the second roller. The first distance between the two rollers is effective to transfer conditioning material from the second roller to the print media. As described above, in one embodiment, the first roller can comprise a pinch roller while the second roller comprises a transfer roller.

The exemplary method does not apply conditioning material to a print media at 604 if the evaluation indicates that print quality will not be improved with the application of the printing material. As described above with relation to act 602, said act of not applying conditioning material can pertain to entire print jobs, full pages or portions of pages, in various suitable embodiments.

As described above, some embodiments avoid applying conditioning material by moving the first roller away from the second roller effective to avoid transferring conditioning material to the print media.

In some of these embodiments, by moving the first roller away from the second roller, the first roller is positioned a second distance from the second roller when print media is not positioned between the first roller and the second roller. The second distance is greater than the first distance and is effective to prevent conditioning material from being transferred from the second roller to the first roller in the absence of print media.

Other embodiments can position the two rollers relative to one another in other suitable manners. For example, in one suitable embodiment, the first roller can comprise a top roller that is positioned proximate to a bottom roller comprising the second roller when a print media is positioned between the top roller and the bottom roller. This position can transfer conditioning material from the bottom roller to the print media. This embodiment can further position the top roller further from the bottom roller when print media is not positioned between the top roller and the bottom roller to prevent conditioning material from being transferred between the two rollers. Various other suitable configurations will be recognized by the skilled artisan.

Although the embodiments have been described in language specific to structural features and/or methodological acts, it is to be understood that the appended claims are not limited to the specific features or acts described.

1. An ink jet printing device comprising:
an ink ejecting sub-assembly for positioning ink on a print media; and,
a conditioning sub-assembly having a plurality of components, wherein the plurality of components has a first configuration to transfer conditioning material to the print media as the print media is fed through the printing device and a second configuration that does not transfer conditioning material to the print media as the print media is fed through the printing device.

2. The ink jet printing device of claim 1, wherein the conditioning sub-assembly comprises a pinch roller and a transfer roller.

3. The ink jet printing device of claim 2, wherein the pinch roller and transfer roller are more proximate one another in the first configuration than in the second configuration.

4. The ink jet printing device of claim 3, wherein the second configuration does not cause conditioning material to be transferred from the transfer roller to the pinch roller in the absence of print media.

5. The ink jet printing device of claim 3 further comprising a cam lever to control the position of the pinch roller.

6. The ink jet printing device of claim 2, wherein the transfer roller is configured to have the conditioning material positioned thereon for transferring to the print media.

7. The ink jet printing device of claim 1, wherein the ink ejecting sub-assembly comprises an ink jet print cartridge.

8. The ink jet printing device of claim 1, wherein the conditioning material comprises water.

9. The ink jet printing device of claim 1, wherein the conditioning material comprises a fixer.

10. The ink jet printing device of claim 1, wherein the conditioning material comprises a hydrophilic compound.

11. The ink jet printing device of claim 1, wherein the ink ejecting sub-assembly and the conditioning subassembly are physically spaced from one another to reduce undesired interaction between the conditioning material and the print unit.

12. The ink jet printing device of claim 1 further comprising a fan for evacuating air-born conditioning material away from the ink ejecting sub-assembly.

13. The ink jet printing device of claim 1 further comprising a barrier positioned between the conditioning sub-assembly and the ink ejecting sub-assembly to reduce undesired interaction of the conditioning material with the ink ejecting sub-assembly.

14. A printing device comprising:
a sub-assembly for positioning ink on a print media; and,
a conditioning sub-assembly having a plurality of components, wherein the plurality of components has a first configuration to transfer conditioning material to the print media as the print media is fed through the printing device and a second configuration that does not transfer conditioning material to the print media as the print media is fed through the printing device.

15. The printing device of claim 14, wherein the printing device comprises a laser printer.

16. The printing device of claim 14, wherein the ink comprises toner.

17. The printing device of claim 14, wherein the ink comprises liquid ink.

18. A printing device comprising:
means for evaluating print stream data to determine whether a conditioning material should be applied to print media upon which an image representing the print stream data is to be formed; and,
means for applying conditioning material to a print media if said act of evaluating indicates that print quality can be improved with the application of the conditioning material, and not applying conditioning material to a print media if said evaluating indicates that print quality will not be improved with the application of the conditioning material.

19. A method comprising:
positioning a first roller a first distance from at least a second roller when a print media is positioned between the first roller and the second roller effective to transfer conditioning material from the second roller to the print media; and,
positioning the first roller a second distance from the second roller when print media is not positioned between the first roller and the second roller, wherein the second distance is greater than the first distance and effective to prevent conditioning material from being transferred from the second roller to the first roller.

20. The method of claim 19, wherein said act of positioning a first roller a first distance comprises positioning the first roller at a first distance that allows the first roller to press the print media against the second roller.

21. A method comprising:
positioning a first roller a first distance from at least a second roller when a print media is positioned between the first roller and the second roller effective to transfer conditioning material from the second roller to the print media; and,
moving the first roller away from the second roller effective to avoid transferring conditioning material to another print media.

22. The method of claim 21, wherein said act of positioning squeezes the print media against the second roller.

23. A method comprising:
feeding print media into a print unit of a printing device; and,
moving a pinch roller between a first position and a second position based, at least in part, on the presence of print media between the pinch roller and a transfer roller, wherein in the first position the pinch roller causes a print media positioned between the pinch roller and the transfer roller to receive a conditioning material from the transfer roller and being in the second position the pinch roller does not cause conditioning material to be transferred to the print media.

24. The method of claim 23, wherein said act of moving is controlled by a controller.

25. A method comprising:
positioning a top roller proximate to a bottom roller when a print media is positioned between the top roller and the bottom roller so that conditioning material is transferred from the bottom roller to the print media; and,
positioning the top roller further from the bottom roller when print media is not positioned between the top roller and the bottom roller to prevent conditioning material from being transferred from the bottom roller to the top roller.

26. The method of claim 25 further comprising ejecting ink onto at least portions of the print media to which conditioning material has been transferred.

27. The method of claim 25 further comprising transferring ink onto at least portions of the print media to which conditioning material has been transferred.

28. The method of claim 25, wherein said act of positioning comprises moving at least one roller relative to the other roller.

29. The method of claim 28, wherein said act of moving comprises moving vertically.

30. The method of claim 28, wherein said act of moving comprises moving the top roller relative to the bottom roller.

31. A method comprising:
applying a hydrophilic material to substantially all of a sheet of print media to pre-expand the print media; and,
transferring ink onto the print media to form a desired image.

32. The method of claim 31, wherein said act of transferring comprises ejecting.

33. The method of claim 31, wherein said act of transferring comprises contacting the print media with a surface upon which the ink is positioned.

34. The method of claim 31, wherein said act of applying a hydrophilic material comprises applying water.

35. A method comprising:
evaluating print stream data to determine whether a conditioning material should be applied to print media upon which an image representing the print stream data is to be formed;
applying conditioning material to a print media if said act of evaluating indicates that print quality can be improved with the application of the conditioning material; and,
not applying conditioning material to a print media if said evaluating indicates that print quality will not be improved with the application of the conditioning material.

36. One or more computer-readable media having computer-readable instructions thereto which, when executed by a printing device, cause the printing device to:
evaluate print stream data to determine whether a conditioning material should be applied to print upon which an image representing the print stream data is to be formed:
apply conditioning material to print media if an evaluation indicates that print quality can be improved with the application of the conditioning material; and
not apply conditioning material to a print media if the evaluation indicates that print quality will be improved with the application of the conditioning material.
